(19) United States
(12) Patent Application Publication
(10) Pub. No.: US 2026/0323420 A1
(43) Pub. Date: Oct. 15, 2026

(54) METHODS AND APPARATUSES FOR UL SYNCHRONIZATION BEFORE PERFORMING CELL CHANGE

(71) Applicant: Lenovo (Beijing) Limited, Beijing (CN)

(72) Inventors: Lianhai Wu, Beijing (CN); Mingzeng Dai, Shanghai (CN); Congchi Zhang, Shanghai (CN); Shuigen Yang, Shanghai (CN); Le Yan, Shanghai (CN)

(73) Assignee: Lenovo (Beijing) Limited, Beijing (CN)

(21) Appl. No.: 19/111,041

(22) PCT Filed: Sep. 27, 2022
(86) PCT No.: PCT/CN2022/121625

§ 371 Date: Mar. 12, 2025

(51) Int. Cl. H04W 36/00; H04W 36/30; H04W 74/0833

(52) U.S. Cl. CPC H04W 36/0072; H04W 36/30; H04W 74/0833

(57) ABSTRACT

Embodiments of the present application relate to methods and apparatuses for uplink (UL) synchronization before performing cell change under a 3rd Generation Partnership Project (3GPP) 5G system or the like. According to an embodiment of the present application, a user equipment (UE) includes a transceiver and a processor coupled to the transceiver, and the processor is configured to receive a radio resource control (RRC) reconfiguration message associated with one or more candidate cells via the transceiver; perform one or more random access (RA) procedures to the one or more candidate cells for getting timing advance (TA), in response to reception of the RRC reconfiguration message; and switch from a source cell to one candidate cell within the one or more candidate cells, in response to reception of an indication associated with the one candidate cell via the transceiver from the source cell.

### TECHNICAL FIELD

Embodiments of the present application generally relate to wireless communication technology, especially to methods and apparatuses for uplink (UL) synchronization before performing cell change.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

Currently, details regarding UL synchronization before performing cell change have not been discussed in 3GPP 5G technology yet.

### SUMMARY

Some embodiments of the present application provide a user equipment (UE). The UE includes a transceiver and a processor coupled to the transceiver; and the processor is configured to receive a radio resource control (RRC) reconfiguration message associated with one or more candidate cells via the transceiver; perform one or more random access (RA) procedures to the one or more candidate cells for getting timing advance (TA), in response to reception of the RRC reconfiguration message; and switch from a source cell to one candidate cell within the one or more candidate cells, in response to reception of a first indication associated with the one candidate cell via the transceiver from the source cell.

In some embodiments, the first indication is included in downlink control information (DCI) or a medium access control (MAC) control element (CE).

In some embodiments, the processor of the UE is configured to initiate the one or more RA procedures to the one or more candidate cells in response to one of: receiving the RRC reconfiguration message including an updated configuration of a first candidate cell, wherein the UE has received a configuration of the first candidate cell before receiving the RRC reconfiguration message, and the UE has no available TA for the first candidate cell; receiving the RRC reconfiguration message including a configuration of a second candidate cell and the UE has no available TA for the second candidate cell; and receiving the RRC reconfiguration message including a configuration for an addition of a third candidate cell.

In some embodiments, in response to the RRC reconfiguration message including a set of configurations of multiple candidate cells, the processor of the UE is configured to: perform multiple RA procedures to the multiple candidate cells for getting the TA at the same time; or select one candidate cell among the multiple candidate cells and perform one RA procedure to the selected one candidate cell for getting the TA at the same time.

In some embodiments, to select the one candidate cell, the processor of the UE is configured to select the one candidate cell from the one or more candidate cells based on at least one of: channel quality of the one or more candidate cells, or channel quality of beams of the one or more candidate cells.

In some embodiments, the processor of the UE is configured to initiate the one or more RA procedures to the one or more candidate cells in response to fulfillment of a configured condition.

In some embodiments, the configured condition is a threshold for channel quality.

In some embodiments, the processor of the UE is configured to receive an indication indicating the UE to perform a RA procedure for getting the TA, or wherein the RRC reconfiguration message includes a set of parameters for getting TA for implicitly indicating the UE to perform the RA procedure for getting the TA.

In some embodiments, the set of parameters includes at least one of: a dedicated preamble, or a dedicated random access channel occasion (RO).

In some embodiments, the indication or the RRC reconfiguration message including the set of parameters for getting TA is generated by the source cell, the one candidate cell, or a centralized unit (CU).

In some embodiments, the RRC reconfiguration message includes at least one of: a dedicated preamble for a RA procedure within the one or more RA procedures for getting the TA; or a dedicated time-frequency domain resource for the RA procedure within the one or more RA procedures for getting the TA.

In some embodiments, the RA procedure within the one or more RA procedures for getting the TA is associated with a timer for RA for getting TA, and the processor of the UE is configured to start the timer for RA for getting TA in response to initiating the RA procedure within the one or more RA procedures for getting the TA.

In some embodiments, the processor of the UE is configured to transmit, via the transceiver to a target distributed unit (DU), a second indication for indicating that the one or more RA procedures are for getting the TA.

In some embodiments, the second indication is transmitted in Msg 3 or Msg A during the one or more RA procedures.

In some embodiments, in response to the reception of the first indication associated with the one candidate cell, the processor of the UE is configured to perform one of: continuing to perform a RA procedure to the one candidate cell for getting the TA; stopping at least one RA procedure to other candidate cells within the one or more candidate cells except the one candidate cell indicated in the first indication; and stopping the RA procedure to the one candidate cell for getting the TA.

In some embodiments, in response to stopping the RA procedure to the one candidate cell, the processor of the UE is configured to stop a timer for RA for getting TA, wherein the timer is associated with the RA procedure to the one candidate cell.

In some embodiments, in response to successful completion of the one or more RA procedures to the one or more candidate cells for getting the TA, the processor of the UE is configured to: determine whether the TA for each candidate cell is invalid; and initiate one RA procedure to the candidate cells for getting updated TA, in response to determining that the TA is invalid.

In some embodiments, to determine whether the TA is invalid, the processor of the UE is configured to: store a RSRP value of the UE upon getting the TA; monitor an updated RSRP value of the UE; and determine that the TA is invalid, in response to a difference between the updated RSRP value and the RSRP value being equal to or greater than a configured threshold.

In some embodiments, to determine whether the TA is invalid, the processor of the UE is configured to: determine whether time duration since a time point of getting the TA is equal to or greater than a configured time period; and determine that the TA is invalid, in response to the time duration being equal to or greater than the configured time period.

In some embodiments, the RRC reconfiguration message includes at least one of the configured threshold or the configured time period.

In some embodiments, the at least one of the configured threshold or the configured time period is generated by the CU or a target distributed unit (DU) managed by the CU.

Some embodiments of the present application provide a target distributed unit (DU). The target DU includes a transceiver and a processor coupled to the transceiver; and the processor is configured to receive a cell change request for a user equipment (UE) via the transceiver from a centralized unit (CU) managing the target DU; and transmit a response via the transceiver to the CU, wherein the response includes a set of configurations regarding a target cell, and wherein the set of configurations are applied by the UE upon reception of a first indication associated with one candidate cell.

In some embodiments, the first indication is included in downlink control information (DCI) or a medium access control (MAC) control element (CE).

In some embodiments, the processor of the target DU is configured to generate at least one of: an indication indicating the UE to perform a random access (RA) procedure for getting timing advance (TA); or a set of parameters for getting the TA for implicitly indicating the UE to perform the RA procedure for getting the TA, wherein the response includes the at least one of the indication or the set of parameters for getting the TA.

In some embodiments, the set of parameters includes at least one of: a dedicated preamble, or a dedicated random access channel occasion (RO).

In some embodiments, the processor of the target DU is configured to receive, via the transceiver from the CU, information for requesting the target DU to provide the at least one of the indication or the set of parameters for getting the TA.

In some embodiments, the processor of the target DU is configured to transmit, via the transceiver to the UE, at least one of: a dedicated preamble for a RA procedure for getting the TA; or a dedicated time-frequency domain resource for the RA procedure for getting the TA.

In some embodiments, the RA procedure for getting the TA is associated with a timer for RA for getting TA.

In some embodiments, the processor of the target DU is configured to receive, via the transceiver from the UE, a second indication for indicating that one or more RA procedures to one or more candidate cells performed by the UE are for getting the TA.

In some embodiments, the second indication is received in Msg 3 or Msg A during the one or more RA procedures.

In some embodiments, the processor of the target DU is configured to: generate at least one of a configured threshold for channel quality or a configured time period; and transmit the at least one of the configured threshold or the configured time period via the transceiver to the UE, wherein whether the TA is invalid is determined by the UE based on the at least one of the configured threshold or the configured time period.

Some embodiments of the present application provide a centralized unit (CU). The CU includes a transceiver and a processor coupled to the transceiver; and the processor is configured to transmit a cell change request for a user equipment (UE) via the transceiver to a target distributed unit (DU) managed by the CU; receive a response via the transceiver from the target DU, wherein the response includes a set of configurations regarding a target cell, and wherein the set of configurations are applied by the UE upon reception of a first indication associated with one candidate cell; and transmit a radio resource control (RRC) reconfiguration message associated with one or more candidate cells via the transceiver to the UE.

In some embodiments, the first indication is included in downlink control information (DCI) or a medium access control (MAC) control element (CE).

In some embodiments, the RRC reconfiguration message includes a set of parameters for getting the TA for implicitly indicating the UE to perform the RA procedure for getting the TA, or wherein the processor of the CU is configured to transmit an indication indicating the UE to perform a RA procedure for getting the TA via the transceiver to the UE.

In some embodiments, the set of parameters includes at least one of: a dedicated preamble, or a dedicated random access channel occasion (RO).

In some embodiments, the processor of the CU is configured to: generate at least one of the indication or the set of parameters for getting the TA; or receive the at least one of the indication or the set of parameters for getting the TA via the transceiver from the target DU.

In some embodiments, before receiving the at least one of the indication or the set of parameters for getting the TA from the target DU, the processor of the CU is configured to transmit, via the transceiver to the target DU, information for requesting the target DU to provide the at least one of the indication or the set of parameters for getting the TA.

In some embodiments, the processor of the CU is configured to transmit at least one of a configured threshold for channel quality or a configured time period via the transceiver to the UE, and wherein whether the TA is invalid is determined by the UE based on the at least one of the configured threshold or the configured time period.

In some embodiments, the processor of the CU is configured to: generate the at least one of the configured threshold or the configured time period; or receive the at least one of the configured threshold or the configured time period via the transceiver from the target DU.

Some embodiments of the present application provide a method performed by a UE. The method includes: receiving a radio resource control (RRC) reconfiguration message associated with one or more candidate cells; performing one or more random access (RA) procedures to the one or more candidate cells for getting timing advance (TA), in response to reception of the RRC reconfiguration message; and switching from a source cell to one candidate cell within the one or more candidate cells, in response to reception of a first indication associated with the one candidate cell from the source cell.

Some embodiments of the present application provide a method performed by a target distributed unit (DU). The method includes: receiving a cell change request for a user equipment (UE) from a centralized unit (CU) managing the target DU; and transmitting a response to the CU, wherein the response includes a set of configurations regarding a target cell, and wherein the set of configurations are applied by the UE upon reception of a first indication associated with one candidate cell.

Some embodiments of the present application provide a method performed by a centralized unit (CU). The method includes: transmitting a cell change request for a user equipment (UE) to a target distributed unit (DU) managed by the CU; receiving a response from the target DU, wherein the response includes a set of configurations regarding a target cell, and wherein the set of configurations are applied by the UE upon reception of a first indication associated with one candidate cell; and transmitting a radio resource control (RRC) reconfiguration message associated with one or more candidate cells to the UE.

Some embodiments of the present application provide an apparatus for wireless communications. The apparatus comprises: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the abovementioned method performed by a UE or a network node (e.g., a base station (BS), a CU, or a DU).

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system according to some embodiments of the present application.

FIG. 2 illustrates a schematic diagram of inter-cell Layer1/Layer2 (L1/L2) mobility in accordance with some embodiments of the present application.

FIG. 3 illustrates an exemplary flowchart of performing RA procedures for getting TA in accordance with some embodiments of the present application.

FIG. 4 illustrates an exemplary flowchart of receiving a cell change request in accordance with some embodiments of the present application.

FIG. 5 illustrates an exemplary flowchart of transmitting a cell change request in accordance with some embodiments of the present application.

FIGS. 6-8 illustrate exemplary flowcharts of performing a cell change procedure in accordance with some embodiments of the present application;

FIG. 9 illustrates a block diagram of an exemplary apparatus in accordance with some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8 and so on. It is contemplated that along with developments of network architectures and new service scenarios, all embodiments in the present application are also applicable to similar technical problems; and moreover, the terminologies recited in the present application may change, which should not affect the principle of the present application.

FIG. 1 illustrates a schematic diagram of a wireless communication system according to some embodiments of the present application. As shown in FIG. 1, the wireless communication system 100 includes at least one base station (BS) 101 and at least one user equipment (UE) 102. In particular, the wireless communication system 100 includes one BS 101 and two UE 102 (e.g., UE 102a and UE 102b) for illustrative purpose. Although a specific number of BSs and UEs are illustrated in FIG. 1 for simplicity, it is contemplated that the wireless communication system 100 may include more or less BSs and UEs in some other embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

BS 101 may communicate with a core network (CN) node (not shown), e.g., a mobility management entity (MME) or a serving gateway (S-GW), a mobility management function (AMF) or a user plane function (UPF) etc. via an interface. A BS also be referred to as an access point, an access terminal, a base, a macro cell, a node-B, an enhanced node B (eNB), a gNB, a home node-B, a relay node, or a device, or described using other terminology used in the art. In 5G NR, a BS may also refer to as a RAN node or network apparatus. Each BS may serve a number of UE(s) within a serving area, for example, a cell or a cell sector via a wireless communication link. Neighbor BSs may communicate with each other as necessary, e.g., during a handover procedure for a UE.

UE 102, e.g., UE 102a and UE 102b, should be understood as any type terminal device, which may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, UE 102 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, UE 102 may include wearable devices, such as smart watches, fitness bands, optical head-mounted displays, or the like. Moreover, UE 102 may be referred to as a subscriber unit, a mobile, a mobile station, a user, a terminal, a mobile terminal, a wireless terminal, a fixed terminal, a subscriber station, a user terminal, or a device, or described using other terminology used in the art. UE 102 may communicate directly with BSs 101 via uplink (UL) communication signals.

In 3GPP Release 18, it has been discussed to support an inter-cell mobility based on Layer1/Layer2 (L1/L2) signaling. In particular, a UE can be provided in advance with configurations from multiple cells, and a BS (e.g., gNB) may switch a UE to a new cell using L1/L2 signaling taking into account the received physical layer measurement result. In accordance with 3GPP standard documents, a BS may consist of a BS-centralized unit (CU) and one or more BS-distributed unit(s) (DU(s)). A BS-CU and a BS-DU are connected via F1 interface which is a logical interface. One BS-DU is connected to only one BS-CU.

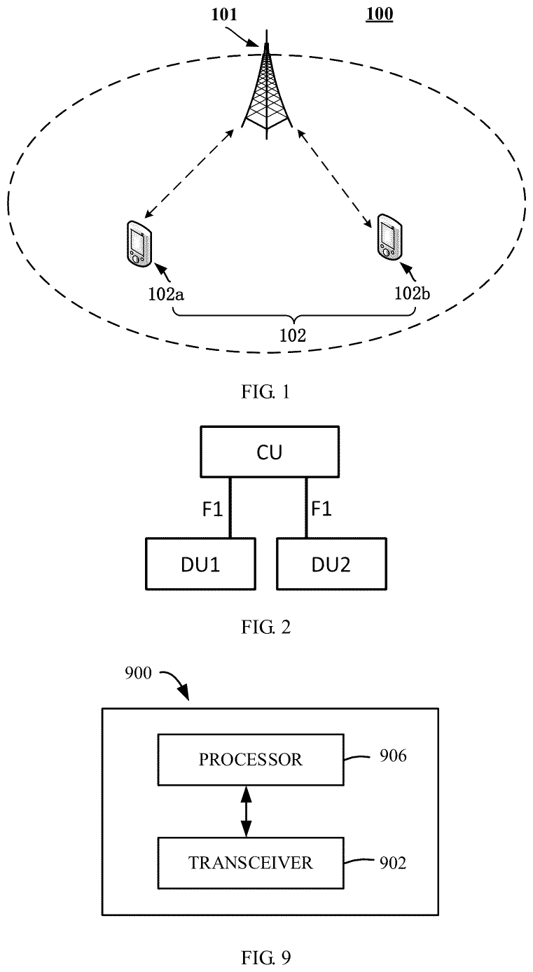

FIG. 2 illustrates a schematic diagram of inter-cell Layer1/Layer2 (L1/L2) mobility in accordance with some embodiments of the present application. As shown in FIG. 2, CU may communicate with two DUs, i.e., DU1 or DU2, via F1 interfaces. CU in FIG. 2 may implement legacy mobility decision based on Layer 3(L3) measurement result. DU1 or DU2 in FIG. 2 may implement L1/L2 mobility decision based on physical layer measurement result.

Compared to legacy L3 mobility, L1/L2 mobility is considered faster with less processing delay and signaling delay. In legacy L3 mobility, a CU (e.g., CU as shown in FIG. 2) makes the mobility decision based on received radio resource management (RRM) measurement report. Different than legacy L3 mobility, in L1/L2 mobility, a DU (e.g., DU1 or DU2 as shown in FIG. 2) makes the mobility decision based on physical layer measurement result, e.g., carried in a channel state information (CSI) report. Besides, in legacy L3 mobility, the handover command is sent via an RRC message from the SN CU to a UE, while in L1/L2 mobility, the “handover” command is sent via L1/L2 signaling (e.g., downlink control information (DCI) or a medium access control (MAC) control element (CE)) from the DU to a UE. The “handover” command in L1/L2 mobility can be about cell activation or deactivation, e.g., activate a new serving PCell while deactivate the old serving PCell.

Currently, an issue of when to perform RA for getting TA (or early TA) after reception of L1/L2 command (e.g., DCI or MAC CE command) has been solved. Some embodiments of the present application study a use case in which a UE receives configuration(s) for a candidate cell, and before executing SpCell change or Scell change, a UE may get TA via a RA procedure. Some embodiments of the present application study a UE's behaviors in a case that a UE receives DCI or MAC CE indication for handover towards one candidate cell when the UE is performing a RA procedure to the candidate cell for getting TA. Some embodiments of the present application study a mechanism of differentiating between a RA procedure of getting TA and a normal RA procedure for handover. Some embodiments of the present application study a mechanism of how to determine whether the TA is invalid after successfully getting TA via a RA procedure.

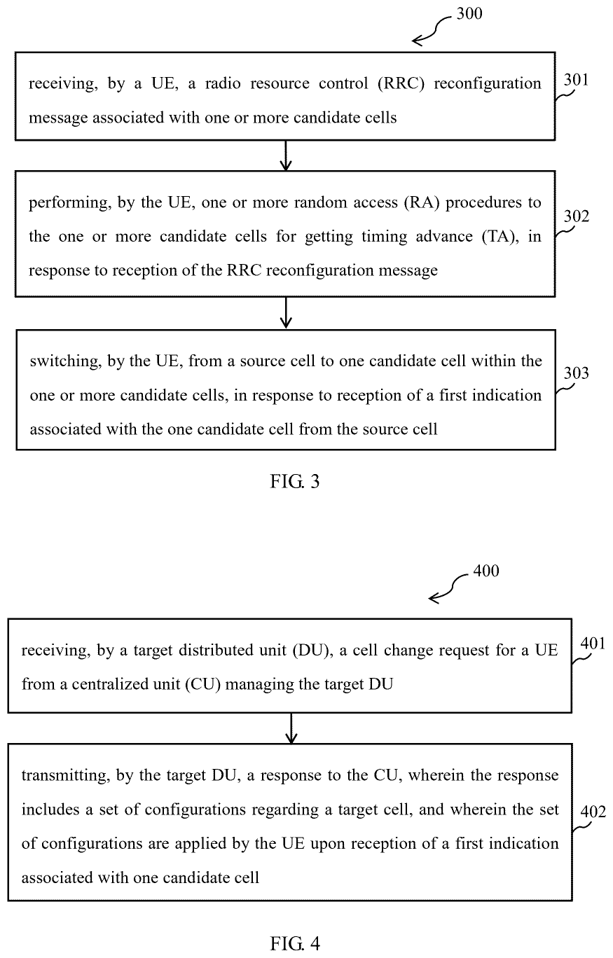

In particular, in embodiments of FIGS. 3-9 of the present application, both inter-DU mobility scenario and intra-DU mobility scenario are considered. Inter-DU mobility means that a connection to a CU remains the same, while a UE may change from a source cell related to a source DU to a target cell related to a target DU due to mobility, while both the source DU and the target DU are managed by the CU. Intra-DU mobility means that a connection to a CU remains the same, while a UE may change from a source cell to a target cell related to the same DU due to mobility. More details will be illustrated in following text in combination with the appended drawings.

FIG. 3 illustrates an exemplary flowchart of performing RA procedures for getting TA in accordance with some embodiments of the present application. The exemplary method 400 in the embodiments of FIG. 3 may be performed by a UE (e.g., UE 102 as shown and illustrated in FIG. 1). Although described with respect to a UE, it should be understood that other devices may be configured to perform a method similar to that of FIG. 3. Details described in all other embodiments of the present application are applicable for the embodiments of FIG. 3. Moreover, details described in the embodiments of FIG. 3 are applicable for all the embodiments of FIGS. 1, 2, and 4-9.

In the exemplary method 300 as shown in FIG. 3, in operation 301, a UE receives an RRC reconfiguration message associated with one or more candidate cells. In operation 302, the UE performs one or more RA procedures to the one or more candidate cells for getting TA, in response to reception of the RRC reconfiguration message.

In operation 303, the UE switches from a source cell to one candidate cell within the one or more candidate cells, in response to reception of an indication associated with the one candidate cell (denoted as indication #1 for simplicity) from the source cell (for example, from a source DU, e.g., DU1 as shown and illustrated in FIG. 2). In some embodiments, indication #1 is included in DCI or a MAC CE. That is, the UE may receive DCI or a MAC CE command or indication associated with the one candidate cell.

In some embodiments, in response to reception of indication #1 associated with the one candidate cell, the UE may perform one of:
(1) continuing to perform a RA procedure to the one candidate cell for getting the TA;
(2) stopping at least one RA procedure to other candidate cells within the one or more candidate cells except the one candidate cell indicated in indication #1; and
(3) stopping the RA procedure to the one candidate cell for getting the TA. In some embodiments, in response to stopping the RA procedure to the one candidate cell, the UE may stop a timer for RA for getting TA, wherein the timer is associated with the RA procedure to the one candidate cell. For instance, the time may be similar to a timer for handover (e.g., T304 as defined in 3GPP standard document), which is associated with a normal RA procedure for handover.

In some embodiments, the UE may initiate the one or more RA procedures to the one or more candidate cells, in response to one of:
(1) receiving the RRC reconfiguration message including an updated configuration of a candidate cell, wherein the UE has received a configuration of this candidate cell before receiving the RRC reconfiguration message, and the UE has no available TA for this candidate cell;
(2) receiving the RRC reconfiguration message including a configuration of a candidate cell and the UE has no available TA for this candidate cell; and
(3) receiving the RRC reconfiguration message including a configuration for an addition of a candidate cell.

In some embodiments, in response to the RRC reconfiguration message including a set of configurations of multiple candidate cells, the UE may perform multiple RA procedures to the multiple candidate cells for getting the TA at the same time.

In some other embodiments, in response to the RRC reconfiguration message including a set of configurations of multiple candidate cells, the UE may select one candidate cell among the multiple candidate cells and perform one RA procedure to the selected one candidate cell for getting the TA at the same time. In an embodiment, the UE may select the one candidate cell from the one or more candidate cells based on: channel quality of the one or more candidate cells, and/or channel quality of beams of the one or more candidate cells.

In some embodiments, the UE may initiate the one or more RA procedures to the one or more candidate cells in response to fulfillment of a configured condition.

In an embodiment, the configured condition is a threshold for channel quality, e.g., “a RSRP threshold” or “a threshold for RSRP change”. A specific example is described in the embodiments of FIG. 8 as follows.

In some embodiments, the UE may receive an indication (e.g., an explicit indication) indicating the UE to perform a RA procedure for getting the TA (denoted as indication #2 for simplicity). In an embodiment, indication #2 is generated by the source cell, the one candidate cell, or a CU (e.g., CU as shown and illustrated in FIG. 2).

In some other embodiments, the RRC reconfiguration message received in operation 301 includes a set of parameters for getting TA for implicitly indicating the UE to perform the RA procedure for getting the TA. In an embodiment, the set of parameters includes a dedicated preamble and/or a dedicated random access channel occasion (RO). In an embodiment, the RRC reconfiguration message including the set of parameters for getting TA is generated by the source cell, the one candidate cell, or a CU (e.g., CU as shown and illustrated in FIG. 2). A specific example is described in the embodiments of FIG. 6 as follows.

In some embodiments, the RRC reconfiguration message received in operation 301 includes at least one of:
(1) A dedicated preamble for a RA procedure within the one or more RA procedures for getting the TA. In an embodiment, a RA procedure for getting TA and a normal RA procedure for handover may be configured with different preambles.
(2) A dedicated time-frequency domain resource for the RA procedure within the one or more RA procedures for getting the TA. In an embodiment, a RA procedure for getting TA and a normal RA procedure for handover may be configured with different time-frequency domain resources.

In some embodiments, the RA procedure within the one or more RA procedures for getting the TA is associated with “a timer for RA for getting TA”. The time may be similar to a timer for handover (e.g., T304). The UE may start the timer for RA for getting TA, in response to initiating the RA procedure within the one or more RA procedures for getting the TA.

In some embodiments, the UE may transmit, to a target DU (e.g., DU2 as shown and illustrated in FIG. 2), an indication for indicating that the one or more RA procedures are for getting the TA. For example, this indication may be transmitted in Msg 3 or Msg A during the one or more RA procedures.

In some embodiments, in response to successful completion of the one or more RA procedures to the one or more candidate cells for getting the TA, the UE may determine whether the TA for each candidate cell is invalid, and initiate one RA procedure to the candidate cells for getting updated TA, in response to determining that the TA is invalid.

In an embodiment, the UE may store a RSRP value of the UE upon getting the TA, monitor an updated RSRP value of the UE, and determine that the TA is invalid in response to a difference between the updated RSRP value and the RSRP value being equal to or greater than “a configured threshold”, e.g., a threshold for RSRP change.

In a further embodiment, the UE may determine whether time duration since a time point of getting the TA is equal to or greater than “a configured time period”, and determine that the TA is invalid in response to the time duration being equal to or greater than “the configured time period”.

For example, the RRC reconfiguration message received in operation 301 includes at least one of “the configured threshold” or “the configured time period”. In some embodiments, at least one of “the configured threshold” or “the configured time period” is generated by the CU or a target DU managed by the CU. A specific example is described in the embodiments of FIG. 8 as follows.

FIG. 4 illustrates an exemplary flowchart of receiving a cell change request in accordance with some embodiments of the present application. The exemplary method 400 in the embodiments of FIG. 4 may be performed by a target DU (e.g., DU1 or DU2 as shown and illustrated in FIG. 2). Although described with respect to a target DU, it should be understood that other devices may be configured to perform a method similar to that of FIG. 4. Details described in all other embodiments of the present application are applicable for the embodiments of FIG. 4. Moreover, details described in the embodiments of FIG. 4 are applicable for all the embodiments of FIGS. 1-3 and 5-9.

In the exemplary method 400 as shown in FIG. 4, in operation 401, a target DU (e.g., DU2 as shown and illustrated in FIG. 2) receives a cell change request for a UE (e.g., UE 102 as shown and illustrated in FIG. 1) from a CU (e.g., CU as shown and illustrated in FIG. 2) managing the target DU.

In operation 402, the target DU transmits a response to the CU. The response includes a set of configurations regarding a target cell. The set of configurations may be applied by the UE upon reception of an indication associated with one candidate cell (denoted as indication #1 for simplicity). For instance, indication #1 may be included in DCI or a MAC CE.

In some embodiments, the target DU may generate “an indication indicating the UE to perform a RA procedure for getting TA” (denoted as indication #2 for simplicity) and/or “a set of parameters for getting the TA for implicitly indicating the UE to perform the RA procedure for getting the TA”. The response transmitted in operation 402 may include indication #2 and/or the set of parameters for getting the TA. In an embodiment, the set of parameters includes at least one of: a dedicated preamble, or a dedicated random access channel occasion (RO). In an embodiment, the target DU may receive, from the CU, information for requesting the target DU to provide indication #2 and/or the set of parameters for getting the TA.

In some embodiments, the target DU may transmit, to the UE, at least one of: a dedicated preamble for a RA procedure for getting the TA; or a dedicated time-frequency domain resource for the RA procedure for getting the TA.

In some embodiments, the RA procedure for getting the TA is associated with a timer for RA for getting TA.

In some embodiments, the target DU may receive, from the UE, an indication for indicating that one or more RA procedures to one or more candidate cells performed by the UE are for getting the TA (denoted as indication #3 for simplicity).

In an embodiment, indication #3 is received in Msg 3 or Msg A during the one or more RA procedures.

In some embodiments, the target DU may generate at least one of a configured threshold for channel quality or a configured time period; and the target DU transmit the at least one of the configured threshold or the configured time period to the UE. Whether the TA is invalid may be determined by the UE based on the at least one of the configured threshold or the configured time period.

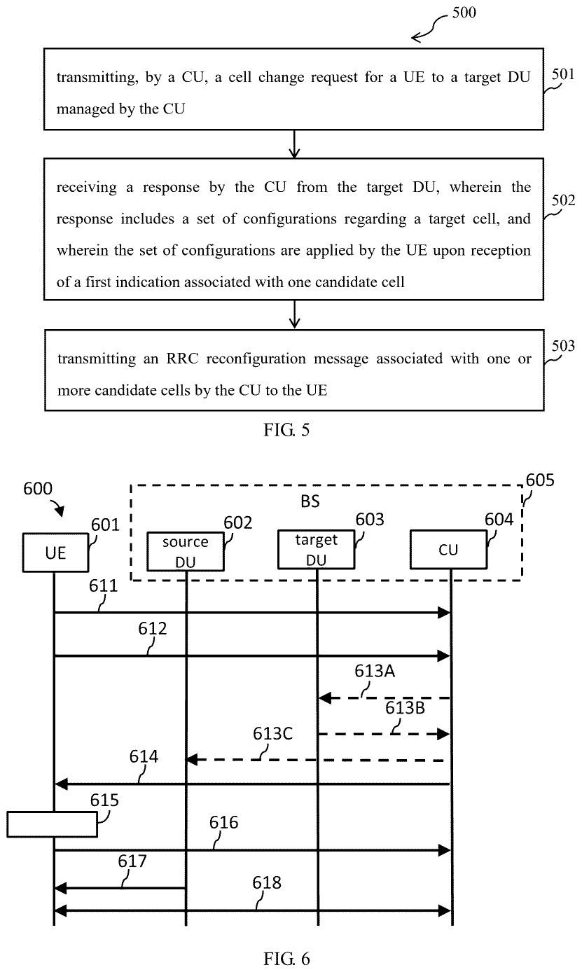

FIG. 5 illustrates an exemplary flowchart of transmitting a cell change request in accordance with some embodiments of the present application. The exemplary method 500 in the embodiments of FIG. 5 may be performed by a CU (e.g., CU as shown and illustrated in FIG. 2). Although described with respect to a CU, it should be understood that other devices may be configured to perform a method similar to that of FIG. 5. Details described in all other embodiments of the present application are applicable for the embodiments of FIG. 5. Moreover, details described in the embodiments of FIG. 5 are applicable for all the embodiments of FIGS. 1-4 and 6-9.

In the exemplary method 500 as shown in FIG. 5, in operation 501, a CU transmits a cell change request for a UE (e.g., UE 102 as shown and illustrated in FIG. 1) to a target DU (e.g., DU2 as shown and illustrated in FIG. 2) managed by the CU.

In operation 502, the CU receives a response from the target DU. The response includes a set of configurations regarding a target cell. The set of configurations are applied by the UE upon reception of an indication associated with one candidate cell (denoted as indication #1 for simplicity). In some embodiments, indication #1 is included in DCI or a MAC CE.

In operation 503, the CU transmits an RRC reconfiguration message associated with one or more candidate cells to the UE. In some embodiments, the RRC reconfiguration message includes a set of parameters for getting the TA for implicitly indicating the UE to perform the RA procedure for getting the TA. In an embodiment, the set of parameters includes at least one of: a dedicated preamble, or a dedicated random access channel occasion (RO). In some other embodiments, the CU may transmit an indication indicating the UE to perform a RA procedure for getting the TA (denoted as indication #2 for simplicity) to the UE.

In some embodiments, the CU may generate indication #2 and/or the set of parameters for getting the TA. In some other embodiments, the CU may receive indication #2 and/or the set of parameters for getting the TA from the target DU.

In some embodiments, before receiving indication #2 and/or the set of parameters for getting the TA from the target DU, the CU may transmit, to the target DU, information for requesting the target DU to provide indication #2 and/or the set of parameters for getting the TA.

In some embodiments, the CU may transmit at least one of “a configured threshold for channel quality” or “a configured time period” to the UE. Whether the TA is invalid may be determined by the UE based on at least one of the configured threshold or the configured time period. In an embodiment, the CU may generate at least one of the configured threshold or the configured time period. In another embodiment, the CU may receive at least one of the configured threshold or the configured time period from the target DU.

FIG. 6 illustrates another exemplary flowchart of performing a cell change procedure in accordance with some embodiments of the present application. Details described in all other embodiments of the present application are applicable for the embodiments shown in FIG. 6. It should be appreciated by persons skilled in the art that the sequence of the operations in exemplary procedure 600 in FIG. 6 may be changed and some of the operations in exemplary procedure 600 in FIG. 6 may be eliminated or modified, without departing from the spirit and scope of the disclosure.

As show in FIG. 6, BS 605 is in CU-DU architecture, and includes CU 604, source DU 602, and target DU 603. In the embodiments shown in FIG. 6, a cell change of UE 601 may refer to an Intra-DU case in which a source cell and a target cell in the same DU or refer to an Inter-DU case in which a source cell and a target cell are located at different DUs. For instance, the flowchart 600 as shown in FIG. 6 only shows a cell change in an Inter-DU case for the exemplary purpose.

In the exemplary flowchart 600 as shown in FIG. 6, in operation 611, UE 601 reports an indication that UE 601 supports the capability of DCI or MAC CE based cell change to the serving cell, e.g., CU 604.

In operation 612, UE 601 reports measurement result(s) via an RRC message to the serving cell, e.g., CU 604. For example, UE 601 may report the measurement result(s) based on the RRC reconfiguration including measurement configuration.

In operation 613A (optional), CU 604 transmits a request for cell change related to DCI or MAC CE based mobility to a target cell, e.g., related to target DU 603. In some embodiments, the CU (e.g., CU 604) requests the target DU (e.g., target DU 603) to provide the configuration of getting TA.

In an embodiment, the source cell and the target cell can be located at the same DU, i.e., in an Intra-DU case in which the serving cell and candidate cell have the same DU. In another embodiment, the source cell and the target cell can be located at different DUs, i.e., in an Inter-DU case, for example, a serving cell is in DU #1 (e.g., source DU 602) and a candidate cell is in DU #2 (e.g., target DU 603). Regarding Intra-DU case and Inter-DU case, the source cell and the target cell share the same CU. In this case, the CU (e.g., CU 604) will transmit “the request for cell change related to DCI or MAC CE based mobility” to the target DU (e.g., target DU 603).

In operation 613B (Optional), the target cell, e.g., related to target DU 603, transmits the response to CU 604. Then, CU 604 will transmit the configuration to source DU 602.

In some embodiments, a network node may indicate to UE 601 whether to get TA. To get TA means that UE 601 needs to ensure UL synchronization before executing cell change. In some cases, “a RA procedure for getting TA” may also be named as “a RA procedure for getting early TA” or the like.

In an embodiment, an explicit indication, which indicates UE 601 to perform a RA procedure for getting the TA, is needed. In another embodiment, it can be implicitly indicated. For instance, the RRC reconfiguration message includes a set of parameters for getting TA, for implicitly indicating UE 601 to perform the RA procedure for getting the TA. For example, when UE 601 receives the set of parameters for getting TA, e.g., a dedicated preamble and/or a dedicated RO, UE 601 considers that the TA is expected.

In some embodiments, whether to get the TA is configured by the target cell (e.g., related to target DU 603) or the serving cell (e.g., CU 604).

In operation 614, the serving cell (e.g., CU 604) transmits the configuration for candidate cell(s) to UE 601 after receiving the response from the target cell, e.g., in operation 613B. That is, UE 601 receives the configuration for candidate cell(s) from the serving cell.

In operation 615, after UE 601 receives the configuration for candidate cell(s) from the serving cell, UE 601 performs a RA procedure for getting TA. In operation 616, UE 601 performs the measurement for the serving cell and candidate cell(s) and reports measurement result(s) to the serving cell.

In some embodiments of FIG. 6, there is a period between receiving the configuration for candidate cell(s) and the reception of “DCI or MAC CE command” (which may also be named as “DCI or MAC CE indication” or “DCI or MAC CE based indication” or the like), e.g., from source DU 602. UE 601 is not aware of the time point of the reception of DCI or MAC CE command. Therefore, the issue when to perform a RA procedure for getting TA needs to be addressed. There may be following three options in different embodiments as below, i.e., Option 1, Option 2, and Option 3.
(1) Option 1: UE 601 performs a RA procedure to the candidate cell when at least one of the following conditions is met:
   a) UE 601 receives the configuration of a candidate cell that has been already configured and UE 601 has no available TA for this candidate cell.
   b) UE 601 receives the configuration of a candidate cell and UE 601 has no available TA for this candidate cell.
   c) UE 601 receives the configuration for the addition of a candidate cell.

In Option 1, when UE 601 receives the configuration of a candidate cell and UE 601 has the available TA, UE 601 does not perform a RA procedure for getting TA. In some cases, if multiple candidate cells are received in a single message, there may be following two options in different embodiments, i.e., Option a and Option b.
Option a: UE 601 can perform multiple RAs at the same time. Namely, UE 601 can maintain multiple ongoing random access procedures at the same time.
Option b: only one RA procedure is allowed to be performed at the same time as legacy.
(2) Option 2: when to perform a RA procedure to a certain candidate cell is based on a configured condition, e.g., the condition is a threshold (e.g., a RSRP value). Once the condition for a candidate cell is met, UE 601 performs a RA procedure to the candidate cell.
(3) Option 3: An explicit indication via DCI or MAC CE, which is used to trigger a RA procedure for getting TA, is transmitted to UE 601.

In some embodiments of FIG. 6, one of following two options can be used to differentiate “a RA procedure for getting TA” from “a normal RA procedure for handover”, i.e., Option A and Option B.
(1) Option A: separate preambles or separate time-frequency domain resources are configured for “a RA procedure for getting TA” and “a normal RA procedure for handover”.
(2) Option B: one indication is added in Msg 3 or Msg A to indicate that “the RA procedure for getting TA” aims to get TA.

In operation 617, based on the above measurement result(s) reported by UE 601, the serving cell transmits DCI or MAC CE indication to UE 601 to activate the cell change.

In operation 618, UE 601 changes the serving cell and starts receiving or transmitting using the pre-configured UE-dedicated channel.

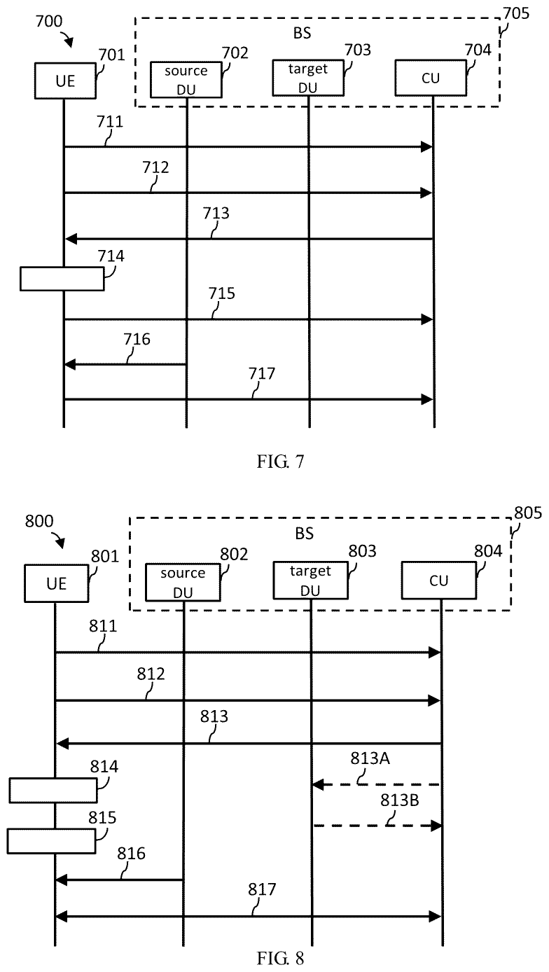

FIG. 7 illustrates another exemplary flowchart of performing a cell change procedure in accordance with some embodiments of the present application. Details described in all other embodiments of the present application are applicable for the embodiments shown in FIG. 7. It should be appreciated by persons skilled in the art that the sequence of the operations in exemplary procedure 700 in FIG. 7 may be changed and some of the operations in exemplary procedure 700 in FIG. 7 may be eliminated or modified, without departing from the spirit and scope of the disclosure.

As show in FIG. 7, BS 705 is in CU-DU architecture, and includes CU 704, source DU 702, and target DU 703. In the embodiments shown in FIG. 7, a cell change of UE 701 may refer to an Intra-DU case in which a source cell and a target cell in the same DU or refer to an Inter-DU case in which a source cell and a target cell are located at different DUs. For instance, the flowchart 700 as shown in FIG. 7 only shows a cell change in an Inter-DU case for the exemplary purpose.

In the exemplary flowchart 700 as shown in FIG. 7, in operation 711, UE 701 reports an indication that UE 701 supports the capability of DCI or MAC CE based cell change to the serving cell, e.g., CU 704.

In operation 712, UE 701 reports measurement result(s) via an RRC message to the serving cell, e.g., CU 704. For instance, UE 701 may report the measurement result(s) based on the RRC reconfiguration including measurement configuration.

In operation 713, the serving cell transmits the configuration for candidate cell(s) to UE 701. The configuration for candidate cell may be generated by the target cell, e.g., by target DU 703.

In operation 714, after UE 701 receives the configuration for candidate cell(s) from the serving cell, UE 701 performs a RA procedure for getting TA. In operation 715, UE 601 performs the measurement for the serving cell and candidate cell(s) and reports measurement result(s) to the serving cell.

In some embodiments of FIG. 7, there is a period between receiving the configuration for candidate cell(s) and the reception of DCI or MAC CE command. UE 701 is not aware of the time point of the reception of DCI or MAC CE command. Therefore, UE 701 can perform a RA procedure for getting TA after receiving the configuration for candidate cell(s).

In some embodiments of FIG. 7, UE 701 wants to get TA before the reception of DCI or MAC CE command. It is possible that UE 701 is performing a RA procedure when receiving the DCI or MAC CE command.

In operation 716, when UE 701 is performing a RA procedure to candidate cell #1 or candidate cell #2 for getting TA, UE 701 may receive the indication via DCI or MAC CE to switch to candidate cell #1, e.g., from source DU 702. There may be following two options in different embodiments, i.e., Option X and Option Y.
(1) Option X: UE 701 continues to perform the RA procedure to candidate cell #1. And, UE 701 may stop the RA procedure to other candidate cell, e.g., candidate cell #2 upon the reception of the indication for candidate cell #1.
(2) Option Y: UE 701 stops the ongoing RA procedure to candidate cell #1 for getting TA and stops the corresponding timer for RA for getting TA. UE 701 starts a timer for handover (e.g., T304 as defined in 3GPP standard document) and performs a new normal RA procedure to candidate cell #1 for handover purpose.

In operation 717, UE 701 transmits an RRC reconfiguration complete message to the target cell after completing the RA procedure.

FIG. 8 illustrates another exemplary flowchart of performing a cell change procedure in accordance with some embodiments of the present application. Details described in all other embodiments of the present application are applicable for the embodiments shown in FIG. 8. It should be appreciated by persons skilled in the art that the sequence of the operations in exemplary procedure 800 in FIG. 8 may be changed and some of the operations in exemplary procedure 800 in FIG. 8 may be eliminated or modified, without departing from the spirit and scope of the disclosure.

As show in FIG. 8, BS 805 is in CU-DU architecture, and includes CU 804, source DU 802, and target DU 803. In the embodiments shown in FIG. 8, a cell change of UE 801 may refer to an Intra-DU case in which a source cell and a target cell in the same DU or refer to an Inter-DU case in which a source cell and a target cell are located at different DUs. For instance, the flowchart 800 as shown in FIG. 8 only shows a cell change in an Inter-DU case for the exemplary purpose.

In the exemplary flowchart 800 as shown in FIG. 8, in operation 811, UE 801 reports an indication that UE 801 supports the capability of DCI or MAC CE based cell change to the serving cell, e.g., CU 804.

In operation 812, UE 801 reports measurement result(s) via an RRC message to the serving cell, e.g., CU 804. For instance, UE 801 may report the measurement result(s) based on the RRC reconfiguration including measurement configuration.

In operation 813, the serving cell, e.g., CU 804, transmits configuration(s) for candidate cell(s) to UE 801.

In some embodiments, in operation 813A (optional), CU 804 may transmit a request for cell change to a target cell, e.g., related to target DU 803, via F1 interface. In operation 813B (optional), the target cell may transmit the response to CU 804.

In operation 814, after UE 801 receives the configuration(s) for the candidate cell(s) from the serving cell, UE 801 performs a RA procedure for getting TA.

In some embodiments, there is a period between receiving the configuration(s) for candidate cell(s) and the reception of DCI or MAC CE command. UE 801 may be not aware of the time point of the reception of DCI or MAC CE command. Therefore, UE 801 can perform a RA procedure for getting TA after receiving the configuration(s) for candidate cell(s).

After successfully getting TA via the RA procedure, the TA could be invalid after a period before receiving the DCI or MAC CE command. Therefore, the network node needs to control when to re-get the TA. In some embodiments, the target cell or the source cell may configure a threshold for channel quality (e.g., a RSRP threshold or a threshold for RSRP change) or a threshold for a period. The threshold can be used by UE 801 to determine whether the TA is valid or not. For example, there may be following options in different embodiments as below, i.e., Option M, Option N, and Option O.
(1) Option M: a RSRP threshold is configured. For example, UE 801 stores RSRP #1 when UE 801 gets TA for the candidate cell. UE 801 will continue to monitor the RSRP. In an embodiment, if RSRP #1 changes to RSRP #2, e.g., RSRP #2 is equal to or greater than a configured RSRP threshold, UE 801 may trigger a RA procedure for TA again.
(2) Option N: a threshold for RSRP change is configured. For example, UE 801 stores RSRP #1 when UE 801 gets TA for the candidate cell. UE 801 will continue to monitor the RSRP. In an embodiment, if RSRP #1 changes to RSRP #2, e.g., a difference between RSRP #2 and RSRP #1 is equal to or greater than a configured threshold for RSRP change, UE 801 may trigger a RA procedure for getting TA again.
(3) Option O: One period is configured. After the configured period since getting TA, UE 801 may determine that the TA is invalid. Then, UE 801 may trigger a RA procedure for getting TA again.

In operation 815, if UE 801 determines that the TA is invalid, UE 801 may perform a RA procedure to get a new TA.

In operation 816, the source cell, e.g., related to source DU 802, transmits a DCI or MAC CE indication to UE 801 to activate a cell change.

In operation 817, UE 801 changes the serving cell and starts receiving or transmitting using the pre-configured UE-dedicated channel.

FIG. 9 illustrates a block diagram of an exemplary apparatus 900 in accordance with some embodiments of the present application. As shown in FIG. 9, the apparatus 900 may include at least one processor 906 and at least one transceiver 902 coupled to the processor 906. Although in this figure, elements such as the at least one transceiver 902 and processor 906 are described in the singular, the plural is contemplated unless a limitation to the singular is explicitly stated. In some embodiments of the subject application, the transceiver 902 may be divided into two devices, such as a receiving circuitry and a transmitting circuitry. In some embodiments of the subject application, the apparatus 900 may further include an input device, a memory, and/or other components.

In some embodiments of the subject application, the apparatus 900 may be a UE or a network node (e.g., a BS, a CU, or a DU). The transceiver 902 and the processor 906 may interact with each other so as to perform the operations with respect to the UE or the network node described above, for example, in any of FIGS. 1-8.

In some embodiments of the subject application, the apparatus 900 may further include at least one non-transitory computer-readable medium. For example, in some embodiments of the present disclosure, the non-transitory computer-readable medium may have stored thereon computer-executable instructions to cause the processor 906 to implement the method with respect to a UE or a network node (e.g., a BS, a CU, or a DU) as described above. For example, the computer-executable instructions, when executed, cause the processor 906 interacting with transceiver 902 to perform the operations with respect to the UE or the network node described in FIGS. 1-8.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including”. Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the subject application, but is not used to limit the substance of the subject application.

What is claimed is:

1. A user equipment (UE) for wireless communication, comprising:
at least one memory; and
at least one processor coupled with the at least one memory and operable to cause the UE to:
receive a radio resource control (RRC) reconfiguration message associated with one or more candidate cells;
perform one or more random access (RA) procedures to the one or more candidate cells for getting timing advance (TA); and
switch from a source cell to one candidate cell within the one or more candidate cells, in response to reception of a first indication associated with the one candidate cell from the source cell.

2. The UE of claim 1, wherein the first indication is included in a medium access control (MAC) control element (CE).

3. The UE of claim 1, wherein the at least one processor is operable to cause the UE to initiate the one or more RA procedures to the one or more candidate cells in response to at least one of:
receiving the RRC reconfiguration message including an updated configuration of a first candidate cell, wherein the UE has received a configuration of the first candidate cell before receiving the RRC reconfiguration message, and the UE has no available TA for the first candidate cell;
receiving the RRC reconfiguration message including a configuration of a second candidate cell and the UE has no available TA for the second candidate cell; or
receiving the RRC reconfiguration message including a configuration for an addition of a third candidate cell.

4. The UE of claim 1, wherein in response to the RRC reconfiguration message including a set of configurations of multiple candidate cells, the at least on processor is operable to cause the UE to:
perform multiple RA procedures to the multiple candidate cells for getting the TA at a same time; or
select one candidate cell among the multiple candidate cells and perform one RA procedure to the selected one candidate cell for getting the TA at a same time.

5. The UE of claim 4, wherein, to select the one candidate cell, the at least one processor is operable to cause the UE to select the one candidate cell from the one or more candidate cells based on at least one of: channel quality of the one or more candidate cells, or channel quality of beams of the one or more candidate cells.

6. The UE of claim 1, wherein the at least one processor is operable to cause the UE to initiate the one or more RA procedures to the one or more candidate cells in response to fulfillment of a configured condition.

7. (canceled)

8. The UE of claim 1, wherein the at least one processor is operable to cause the UE to receive a second indication for the UE to perform a RA procedure for getting the TA.

9. The UE of claim 8, wherein the RRC reconfiguration message includes a set of parameters for getting TA for implicitly indicating the UE to perform the RA procedure for getting the TA, and the set of parameters includes at least one of: a dedicated preamble, or a dedicated random access channel occasion (RO).

10. The UE of claim 8, wherein the second indication is received from the source cell.

11. The UE of claim 1, wherein the RRC reconfiguration message includes at least one of:
a dedicated preamble for a RA procedure within the one or more RA procedures for getting the TA; or
a dedicated time-frequency domain resource for the RA procedure within the one or more RA procedures for getting the TA.

12. The UE of claim 11, wherein the RA procedure within the one or more RA procedures for getting the TA is associated with a timer for RA for getting TA, and the at least one processor is operable to cause the UE to start the timer for RA for getting TA in response to initiating the RA procedure within the one or more RA procedures for getting the TA.

13. The UE of claim 1, wherein the at least one processor is operable to cause the UE to transmit, to a target distributed unit (DU), a second indication for indicating that the one or more RA procedures are for getting the TA.

14. A target distributed unit (DU) for wireless communication, comprising:
at least one memory; and
at least one processor coupled with the at least one memory and operable to cause the target DU to:
receive a cell change request for a user equipment (UE) from a centralized unit (CU) managing the target DU; and
transmit a response to the CU, wherein the response includes a set of configurations regarding a target cell, and wherein the set of configurations are applied by the UE upon reception of a first indication associated with one candidate cell.

15. A centralized unit (CU), comprising:
at least one memory; and
at least one processor coupled with the at least one memory and operable to cause the CU to:
transmit a cell change request for a user equipment (UE) to a target distributed unit (DU) managed by the CU;
receive a response from the target DU, wherein the response includes a set of configurations regarding a target cell, and wherein the set of configurations are applied by the UE upon reception of a first indication associated with one candidate cell; and
transmit a radio resource control (RRC) reconfiguration message associated with one or more candidate cells to the UE.

16. The UE of claim 8, wherein the second indication is received via downlink control information (DCI).

17. The UE of claim 13, wherein the second indication is transmitted in Msg 3 or Msg A during the one or more RA procedures.

18. The target DU of claim 14, wherein the at least one processor is operable to cause the target DU to:
generate a set of parameters for getting timing advance (TA) for indicating to the UE to perform a random access (RA) procedure for getting the TA.

19. The target DU of claim 18, wherein the at least one processor is operable to cause the target DU to:
receive, from the CU, information for requesting the target DU to provide the at least one of the indication or the set of parameters for getting the TA.

20. The target DU of claim 18, wherein the at least one processor is operable to cause the target DU to:
receive, from the UE, a second indication for indicating that one or more RA procedures to one or more candidate cells performed by the UE are for getting the TA.

21. A method performed by a user equipment (UE), the method comprising:
receiving a radio resource control (RRC) reconfiguration message associated with one or more candidate cells;
performing one or more random access (RA) procedures to the one or more candidate cells for getting timing advance (TA); and
switching from a source cell to one candidate cell within the one or more candidate cells, in response to reception of a first indication associated with the one candidate cell from the source cell.
